(19) United States
(12) Patent Application Publication
(10) Pub. No.: US 2024/0010502 A1
(43) Pub. Date: Jan. 11, 2024

(54) POLYCRYSTAL SILICON ROD, POLYCRYSTAL SILICON ROD PRODUCTION METHOD, AND POLYCRYSTAL SILICON THERMAL PROCESSING METHOD

(71) Applicant: TOKUYAMA CORPORATION, Yamaguchi (JP)

(72) Inventors: Junya SAKAI, Yamaguchi (JP); Akira HAKOMORI, Yamaguchi (JP)

(21) Appl. No.: 18/037,966

(22) PCT Filed: Sep. 1, 2021
(86) PCT No.: PCT/JP2021/032101

§ 371 Date: May 19, 2023

(30) Foreign Application Priority Data
Nov. 27, 2020 (JP) 2020-197601

(51) Int. Cl. C01B 33/035

(52) U.S. Cl. CPC C01B 33/035; C01P 2006/80

(57) ABSTRACT

In order to improve a purity of an entire polycrystalline silicon rod, a polycrystalline silicon rod (1) is configured such that: an outer-side total concentration (C1) is 100 pptw or less; and a ratio of an outer-side total concentration (C1) to an inner-side total concentration (C2) is 1.0 or more and 2.5 or less.

### TECHNICAL FIELD

The present invention relates to a polycrystalline silicon rod, a method for producing the polycrystalline silicon rod, and a method for thermally treating polycrystalline silicon.

### BACKGROUND ART

As a method for producing polycrystalline silicon, the Siemens method (bell jar method) is known. In the Siemens method, a raw material gas containing a chlorosilane compound and hydrogen is fed into a reactor while a core wire for silicon deposition (hereinafter, “silicon core wire”) inside the reactor is heated by causing an electric current to pass through the silicon core wire. This causes polycrystalline silicon to be deposited on a surface of the silicon core wire. Patent Literature 1 discloses a technique for reducing distortion of polycrystalline silicon by thermally treating the polycrystalline silicon after deposition of the polycrystalline silicon by the Siemens method.

### CITATION LIST

### Patent Literature

[Patent Literature 1]
Japanese Patent No. 3357675

### SUMMARY OF INVENTION

### Technical Problem

However, in a technique disclosed in Patent Literature 1, a polycrystalline silicon rod is heated until a surface temperature of the polycrystalline silicon rod reaches a high temperature of 1030 degrees or higher. Therefore, there is a possibility that a concentration of impurities may increase in the polycrystalline silicon rod, particularly in a portion in the vicinity of the surface of the polycrystalline silicon rod. In other words, particularly, the portion in the vicinity of the surface of the polycrystalline silicon rod has a low purity. The term “purity” refers to how low a content of impurities is in a certain portion of the polycrystalline silicon rod. An aspect of the present invention has been attained in view of the above problem. An object of an aspect of the present invention is to improve the purity of an entirety of a polycrystalline silicon rod by improving the purity of a portion in the vicinity of a surface of the polycrystalline silicon rod.

### Solution to Problem

In order to solve the above problem, a polycrystalline silicon rod in accordance with an aspect of the present invention has: an outer-side total concentration of 100 pptw or less, the outer-side total concentration being obtained by summing up respective concentrations of iron, chrome, and nickel in a portion of up to 4 mm in depth in a radial direction from a surface parallel to a center axis; and a ratio of the outer-side total concentration to an inner-side total concentration of 1.0 or more and 2.5 or less, the inner-side total concentration being obtained by summing up respective concentrations of the iron, the chrome, and the nickel in a portion farther than 4 mm in the radial direction from the surface.

In order to solve the above problem, a method, in accordance with an aspect of the present invention, for producing a polycrystalline silicon rod includes the steps of: depositing polycrystalline silicon on a surface of a silicon core wire by heating the silicon core wire in the presence of a chlorosilane compound and hydrogen; and thermally treating, in the presence of at least one gas selected from the group consisting of gases of hydrogen, argon and helium, the polycrystalline silicon having been deposited in the step of depositing the polycrystalline silicon, the polycrystalline silicon, in the step of thermally treating the polycrystalline silicon, having a surface temperature T2 of (T1+30° C.) or higher and (T1+100° C.) or lower for a period of time, the surface temperature T2 being lower than 1030° C., where T1 represents a surface temperature of the polycrystalline silicon at a time point at which a value of an electric current caused to pass through the silicon core wire in heating the silicon core wire starts to be decreased in the step of depositing the polycrystalline silicon.

In order to solve the above problem, a method, in accordance with an aspect of the present invention, for thermally treating polycrystalline silicon includes the step of thermally treating the polycrystalline silicon inside a straight barrel part of a reactor in the presence of at least one gas selected from the group consisting of gases of hydrogen, argon and helium, the step of thermally treating the polycrystalline silicon including a period in which a value of F1/S is 20 Nm³/hr/m² or more, where F1 represents a flow rate of a first annealing gas which is the gas that flows into the reactor, and S represents a cross sectional area of the straight barrel part.

### Advantageous Effects of Invention

An aspect of the present invention makes it possible to improve the purity of an entire polycrystalline silicon rod.

### BRIEF DESCRIPTION OF DRAWINGS

FIG. 1 is a view schematically illustrating a polycrystalline silicon rod in accordance with an embodiment of the present invention.

FIG. 2 is a view illustrating a sample in accordance of an embodiment of the present invention.

FIG. 3 is a flow chart illustrating an example of a method for producing the polycrystalline silicon rod illustrated in FIG. 1.

FIG. 4 is a graph showing an example of a hydrogen flow rate etc. in each of steps in the method illustrated in FIG. 3.

FIG. 5 is a view schematically illustrating a reactor that is used for producing the polycrystalline silicon rod illustrated in FIG. 1.

### DESCRIPTION OF EMBODIMENTS

The following will discuss an embodiment of the present invention. Note that, in the present specification, with regard to a numerical value X and a numerical value Y (where X<Y) other than reference signs of members, the expression “X to Y” means “X or more and Y or less”.

[Polycrystalline Silicon Rod]

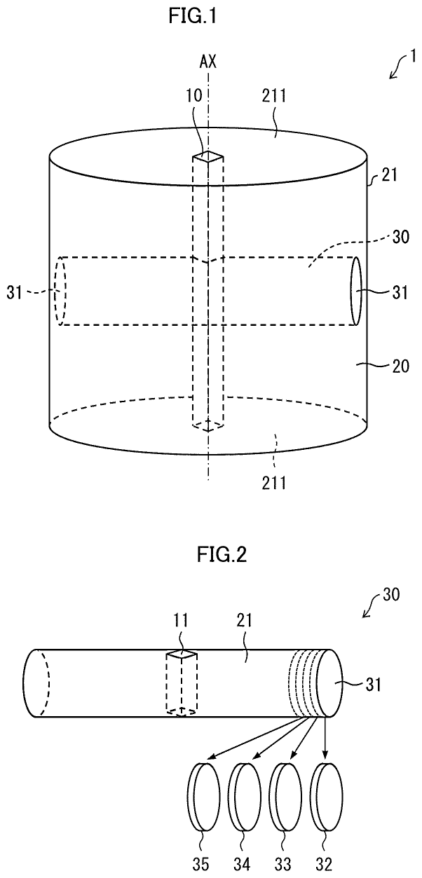

The following will discuss a polycrystalline silicon rod 1 in accordance with an embodiment of the present invention, with reference to FIG. 1. As illustrated in FIG. 1, the polycrystalline silicon rod 1 is formed of a silicon core wire 10 and polycrystalline silicon 20 which is deposited around the silicon core wire 10. Further, the polycrystalline silicon rod 1 has a cylindrical outer shape. Such a polycrystalline silicon rod 1 can be produced by, for example, the Siemens method.

FIG. 1 shows, as an example, the polycrystalline silicon rod 1 that is obtained by cutting, to a predetermined length, the polycrystalline silicon 20 which has been deposited around the silicon core wire 10. The diameter of the polycrystalline silicon rod 1 is not particularly limited. The polycrystalline silicon rod 1 may have a large diameter of, for example, 100 mm or more.

In a case where the diameter of a polycrystalline silicon rod becomes 100 mm or more, a typical polycrystalline silicon rod is likely to have a larger impurity content in an outer portion than in an inner portion. However, in the polycrystalline silicon rod 1, the impurity content in the outer portion can be efficiently decreased. This can ultimately improve the purity of an entirety of the polycrystalline silicon rod 1. In addition, in the case where the diameter of a polycrystalline silicon rod becomes 100 mm or more, a typical polycrystalline silicon rod tends to have a high internal distortion rate and further tends to have a high collapse rate. However, the polycrystalline silicon rod 1 can have a lower internal distortion rate and therefore a lower collapse rate than a conventional polycrystalline silicon rod. Note that an upper limit of the diameter of the polycrystalline silicon rod 1 is not particularly limited. The upper limit is preferably 200 mm or less, and 150 mm or less. Furthermore, the length of the polycrystalline silicon rod 1 is also not particularly limited. However, the length is preferably approximately 150 cm to 250 cm.

The polycrystalline silicon rod 1 has an outer-side total concentration C1 of 100 pptw or less. The outer-side total concentration C1 is obtained by summing up respective concentrations of iron, chrome, and nickel in a portion (hereinafter, “portion in the vicinity of surface 21”) of up to 4 mm in depth in a radial direction from the surface 21 parallel to a center axis AX of the polycrystalline silicon rod 1. The center axis AX of the polycrystalline silicon rod 1 coincides with a center axis of the silicon core wire 10 as illustrated in FIG. 1. In the present specification, the “radial direction” refers to a direction orthogonal to or substantially orthogonal to the center axis of the polycrystalline silicon rod 1. Iron, chrome, and nickel are all impurities that are contained in the polycrystalline silicon rod 1. Hereinafter, these iron, chrome, and nickel may be collectively referred to as “impurities”. Note that, from the viewpoint of further improving the purity in the portion in the vicinity of the surface 21, the outer-side total concentration C1 is preferably 80 pptw or less, and more preferably 60 pptw or less.

Further, the polycrystalline silicon rod 1 has a ratio of the outer-side total concentration C1 to an inner-side total concentration C2, that is, C1/C2 of 1.0 to 2.5. The inner-side total concentration C2 is a value obtained by summing up respective concentrations of iron, chrome, and nickel in a portion (hereinafter, “portion on a center axis AX side”) that is farther than 4 mm in the radial direction from the surface 21 of the polycrystalline silicon rod 1. The inventors of the present invention have found that the outer-side total concentration C1 tends to be higher than the inner-side total concentration C2. As a result of diligent studies based on this finding, the inventors of the present invention have found the above numerical value range.

In the polycrystalline silicon rod 1, C1/C2 is set to 1.0 to 2.5. This makes it possible to improve the purity of the entirety of the polycrystalline silicon rod 1. Note that, from the viewpoint of further improving the purity of the entirety of the polycrystalline silicon rod 1, C1/C2 is preferably 2.0 or less, and more preferably 1.5 or less. For a similar reason, the inner-side total concentration C2 of the polycrystalline silicon rod 1 is preferably 60 pptw or less, and more preferably 40 pptw or less.

The polycrystalline silicon rod 1 has an internal distortion rate of less than 1.0×10⁻⁴ cm⁻¹ in the radial direction. Therefore, it is possible to reduce the collapse rate of the polycrystalline silicon rod 1 as compared to a conventional polycrystalline silicon rod. The internal distortion rate can be defined by a well-known definition and can be calculated by a well-known method. For example, the internal distortion rate can be calculated by a method disclosed in Patent Literature 1, page 6, line 20 to page 7, line 10. Furthermore, the definition disclosed in Patent Literature 1, page 7, lines 11 to 30 is used as the definition of the internal distortion rate. Note that in a case where the polycrystalline silicon rod 1 is used as a raw material for pulling up a single crystal by recharging or the like, the polycrystalline silicon rod 1 preferably has an internal distortion rate of 9.0×10⁻⁵ cm−1 or less so that even when the polycrystalline silicon rod 1 is directly supplied to the reactor 100 (described later), rod cracking is unlikely to occur.

<Method for Calculating Outer-Side Total Concentration and Inner-Side Total Concentration of Polycrystalline Silicon Rod>

Next, the following will discuss a method for calculating the outer-side total concentration and the inner-side total concentration of the polycrystalline silicon rod 1, with reference to FIGS. 1 and 2. The outer-side total concentration C1 and the inner-side total concentration C2 of the polycrystalline silicon rod 1 can be calculated, for example, by the following method.

First, a core rod 30 illustrated in FIG. 1 is extracted from the polycrystalline silicon rod 1. Specifically, the core rod 30 is extracted from the polycrystalline silicon rod 1 substantially perpendicularly to the center axis AX from a predetermined position in a height direction. The predetermined position is based on a first end surface 211 or a second end surface 212. Examples of the “predetermined position in the height direction” of the above description include a position at the center in the height direction of the polycrystalline silicon rod 1.

The core rod 30 has a cylindrical outer shape, and includes a portion 11 of the silicon core wire 10. It is possible to employ a well-known method as an extraction method. The core rod 30 is extracted according to, for example, a method that is described in ASTM F1723-96 “Standard Practice for Evaluation Silicon Rods by Float-Zone Crystal Growth and Spectroscopy”.

Note that, in the present embodiment, a part that conforms to the method described in ASTM F1723-96 is only a part that is used to extract the core rod 30 from the polycrystalline silicon rod 1. Specifically, first, a hole is drilled in the polycrystalline silicon rod 1 that has been obtained by depositing the polycrystalline silicon 20 on the silicon core wire 10. Then, a cylinder (core rod 30) having a diameter of 20 mm is extracted.

Both end surfaces 31 of the core rod 30 are portions of the surface 21 of the polycrystalline silicon rod 1, and each of the end surfaces 31 is curved in accordance with the shape of the surface 21. The diameter of the core rod 30 is not particularly limited, and can be arbitrarily set. In the present embodiment, the core rod 30 has a diameter of approximately 20 mm.

Next, as illustrated in FIG. 2, a substantially disc-shaped rod piece having a maximum thickness of approximately 4 mm is cut from an end surface 31 side of the core rod 30 and substantially perpendicularly to a center axis (not illustrated) of the core rod 30. A surface of this rod piece on a side opposite to a cut surface of the rod piece is the end surface 31 of the core rod 30. Further, the rod piece has a maximum thickness that corresponds to the shortest distance from the most protruding apex of the end surface 31 to the cut surface. Hereinafter, the rod piece including the end surface 31 will be referred to an “outer skin rod piece 32”.

Furthermore, three disc-shaped rod pieces each having a thickness of approximately 4 mm are cut, in the same manner as described above, from a cut surface side of the core rod 30 after the outer skin rod piece 32 has been cut. Hereinafter, the three rod pieces are referred to as “first rod piece 33, second rod piece 34, and third rod piece 35” in order corresponding to the order in which the rod pieces were cut. Further, the outer skin rod piece 32 and the first rod piece 33, the second rod piece 34 and the third rod piece 35 are collectively referred to as “measurement rod pieces 32 to 35”. Note that the number of the measurement rod pieces is not particularly limited except that the measurement rod pieces includes the outer skin rod piece 32.

Examples of a tool used to prepare the measurement rod pieces 32 to 35 by cutting the core rod 30 include a diamond cutter. The diamond cutter has a blade that has a thickness of, for example, 0.7 mm to 1.2 mm and therefore requires a margin of cut of approximately 1.5 mm.

The outer skin rod piece 32 corresponds to a portion of the polycrystalline silicon rod 1 from the surface 21 to a depth of 4 mm in the radial direction (the center axis direction of the core rod 30) of the polycrystalline silicon rod 1. Furthermore, the first rod piece 33, the second rod piece 34 and the third rod piece 35 each are a portion of the polycrystalline silicon rod 1 and correspond to a portion farther than 4 mm in the radial direction of the polycrystalline silicon rod 1 from the surface 21. Note that the maximum thickness of the outer skin rod piece 32 and the thicknesses of the first rod piece 33, the second rod piece 34, and the third rod piece 35 need not be approximately 4 mm. As these thicknesses, a thickness of 3 mm to 10 mm is sufficient, and a thickness of 4 mm to 6 mm is preferable.

In the present embodiment, the outer-side total concentration C1 of the polycrystalline silicon rod 1 corresponds to a total concentration of respective concentrations of the impurities that are contained in the outer skin rod piece 32. The following will discuss in detail a reason why the outer skin rod piece 32 is specified to be a portion (hereinafter, abbreviated as “portion of up to approximately 4 mm in depth”) of up to approximately 4 mm in depth in the radial direction of the polycrystalline silicon rod 1 from the surface 21.

The outer skin rod piece 32 is curved such that a surface of an outer skin-side portion protrudes outward. Therefore, the outer skin rod piece 32 is obtained by cutting at a depth of approximately 4 mm with reference to a point (a center portion in the radial direction of the outer skin rod piece 32) that protrudes outward most in the outer skin-side portion. Thus, the thickness (maximum thickness) of the center portion in the radial direction of the outer skin rod piece 32 is approximately 4 mm.

The outer skin rod piece 32 is prepared by cutting in a direction parallel to the center axis of the polycrystalline silicon rod 1. Therefore, the outer skin rod piece 32 decreases in thickness from the center portion in the radial direction of the outer skin rod piece 32 toward the periphery of the outer skin rod piece 32 (in a direction toward a circumference of the polycrystalline silicon rod 1). For example, in a case where the core rod 30 having a diameter of 20 mm is extracted from the polycrystalline silicon rod 1 having a diameter of 100 mm (radius of 50 mm), the outer skin rod piece 32 has an end portion having a thickness of approximately 3 mm. Furthermore, since the polycrystalline silicon rod 1 has an outer surface that is not smooth, it is necessary to consider surface roughness (Ra). Normally, the outer skin of the polycrystalline silicon rod 1 has a surface roughness (Ra) of approximately 1 mm. In other words, the outer skin rod piece 32 has an uneven thickness that varies by approximately 1 mm.

In view of the shape of the polycrystalline silicon rod 1 and cutting by the blade of the diamond cutter as described above, it is possible to stably and accurately determine the outer-side total concentration C1 by specifying the outer skin rod piece 32 as a portion of up to approximately 4 mm in depth. For example, in view of a protruding form of the surface of the outer skin-side portion of the polycrystalline silicon rod 1 and the surface roughness (Ra) of the surface, if the outer skin rod piece 32 were specified as a portion of up to approximately 2 mm or less in depth, the outer skin rod portion 32 would be easily chipped or damaged when cut by the diamond cutter. This would make it impossible to stably prepare the outer skin rod piece 32. On the other hand, for example, if the outer skin rod piece 32 were specified as a portion of up to approximately 6 mm or more in depth, the impurity content of the outer skin-side portion that is contaminated would be lower than a true value due to dilution. Therefore, such an outer skin rod piece 32 would not be suitable for quality evaluation. In view of the above, the outer skin rod piece 32 is specified as a portion of up to approximately 4 mm in depth in the present embodiment.

After those measurement rod pieces 32 to 35 as described above are prepared, the concentration of the impurities is measured for each of the measurement rod pieces 32 to 35. The following description will discuss, as an example, a method for measuring the concentration of the impurities that are contained in the outer skin rod piece 32. The first rod piece 33, the second rod piece 34 and the third rod piece 35 are also subjected to concentration measurement in the same manner.

First, an entire surface of the outer skin rod piece 32 is etched and removed by approximately 100 μm with use of a nitric hydrofluoric acid solution. This suppresses processing contamination at the time when the core rod 30 is extracted and at the time when the outer skin rod piece 32 is cut. Next, the outer skin rod piece 32 is washed with water and dried. Thereafter, a mass of the outer skin rod piece 32 is measured. Next, a total amount of the outer skin rod piece 32 is dissolved in a predetermined amount of the nitric hydrofluoric acid solution (e.g., 200 ml of nitric acid and 200 ml of hydrofluoric acid). Thereafter, respective masses of iron, chrome, and nickel that are contained in a resultant solution are measured by an inductively coupled plasma mass spectrometer (ICP-MS) that is well-known. Such analysis by ICP-MS is carried out, for example, in accordance with JIS General Rules (JIS K 0133 2007JIS General Rules for High Frequency Plasma Mass Spectrometry).

Next, with use of a measurement result thus obtained, the concentration of the impurities that are contained in the outer skin rod piece 32 is calculated. Specifically, each of the respective concentrations of iron, chrome, and nickel are calculated by dividing a corresponding one of the respective masses of the iron, the chrome and the nickel by the mass of the outer skin rod piece 32. Then, the concentration of the impurities of the outer skin rod piece 32 is calculated by summing up the above concentrations

The concentration of the impurities which is thus calculated is, in other words, the total concentration obtained by summing up the respective concentrations of iron, chrome, and nickel that are contained in the outer skin rod piece 32. In other words, such an impurity concentration in the outer skin rod piece 32 is the outer-side total concentration C1. In line with this idea, in the present embodiment, the inner-side total concentration C2 is defined to be a value that is obtained by averaging respective impurity concentrations of the first rod piece 33, the second rod piece 34, and the third rod piece 35. Note that, in a case where the respective impurity concentrations of the first rod piece 33, the second rod piece 34 and the third rod piece 35 are substantially equal to each other, any one of the impurity concentrations of the first rod piece 33, the second rod piece 34 and the third rod piece 35 may be regarded as the inner-side total concentration C2.

[Method for Producing Polycrystalline Silicon Rod]

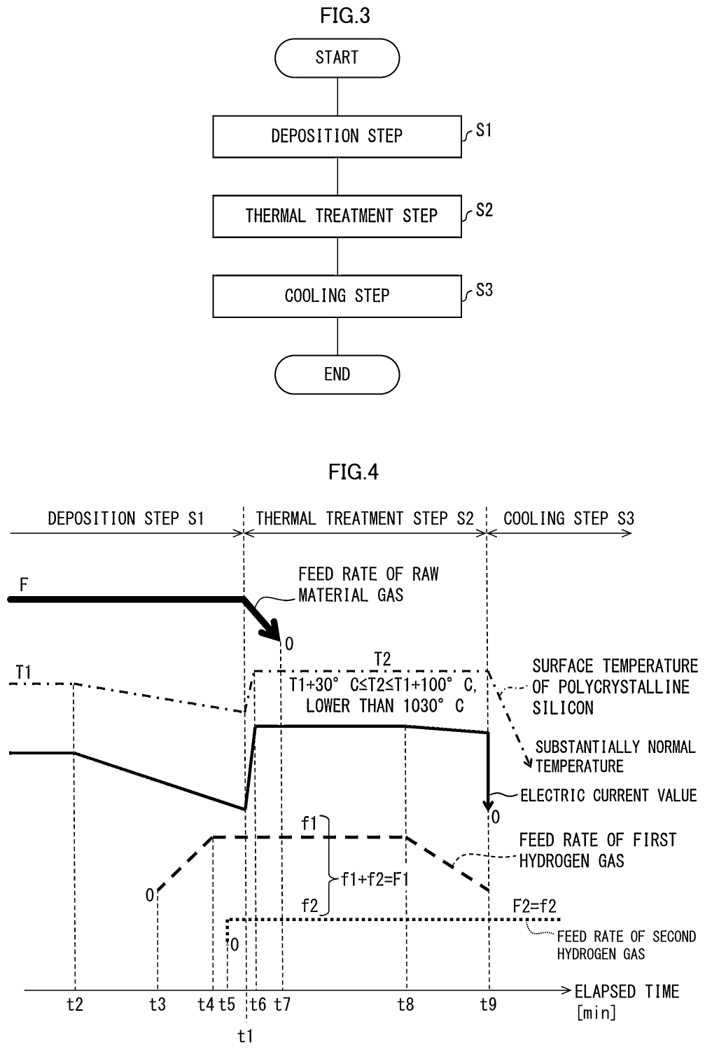

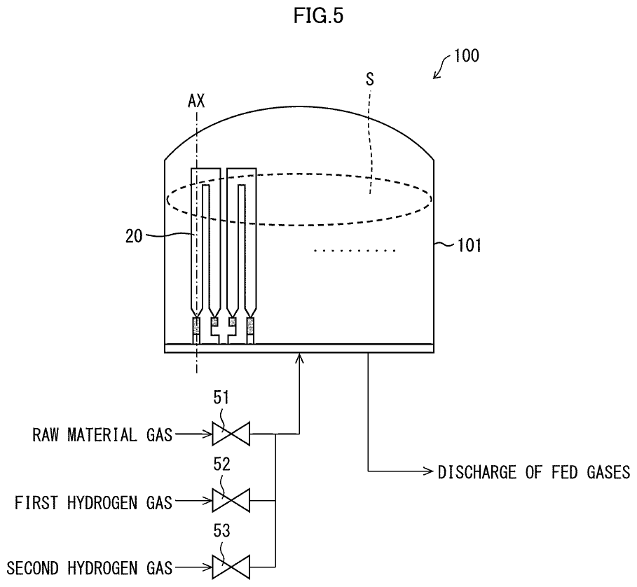

Next, the following will discuss a method for producing the polycrystalline silicon rod 1 in accordance with an embodiment of the present invention, with reference to FIGS. 3 to 5. As illustrated in FIGS. 3 and 4, the method for producing the polycrystalline silicon rod 1 includes a deposition step S1, a thermal treatment step S2, and a cooling step S3.

Note that with reference to a point t1 at which the deposition step S1 is completed, in other words, a point t1 at which the thermal treatment step S2 starts, operation points (points t2 to t9) before and after the point t1 are plotted on the horizontal axis in a graph shown in FIG. 4. The horizontal axis represents, in unit of [min.] (minutes), an elapsed time t from a time at which the deposition step S1 starts. In production of first to third samples and production of comparative sample, (i) respective feed rates of a raw material gas and first and second hydrogen gases and (ii) a value of an electric current are controlled as shown in the graph of FIG. 4. This allows a surface temperature of the polycrystalline silicon 20 in each of the above steps to be adjusted as shown in the graph of FIG. 4. The first to third samples, the comparative sample, the raw material gas, and the first and second hydrogen gases will be described in detail later.

Further, in the present embodiment, the deposition step S1 and the thermal treatment step S2 are carried out in series. Therefore, the point t1 in the graph of FIG. 4, that is, a time point at which the feed rate of the raw material gas starts to be decreased is a time point at which the deposition step S1 ends and also is a time point at which the thermal treatment step S2 starts. Furthermore, in the present embodiment, the point t9 in the graph of FIG. 4, that is, a time point at which application of the electric current to the silicon core wire 10 is stopped is a time point at which the thermal treatment step S2 ends and also is a time point at which the cooling step S3 starts.

<Deposition Step>

First, in the deposition step S1, the polycrystalline silicon 20 is deposited by the Siemens method that is well-known. In the Siemens method, the reactor 100 as illustrated in FIG. 5 is typically used. The reactor 100 is composed of a straight barrel part 101 and a hemispherical surface part which is formed on an upper side of the straight barrel part 101. The silicon core wire 10 is heated in the presence of a chlorosilane compound and hydrogen inside the straight barrel part 101. This causes the polycrystalline silicon 20 to be deposited on the surface of the silicon core wire 10. Hereinafter, a gas containing a chlorosilane compound and hydrogen will be referred to as a “raw material gas”. Note that the straight barrel part 101 has a cross sectional area that is, specifically, an area S of a region which is surrounded by an inner wall surface (see the broken line in FIG. 5) of the straight barrel part 101 when the straight barrel part 101 is cut along a virtual plane orthogonal to the center axis AX in the height direction of the polycrystalline silicon rod 1, as illustrated in FIG. 5.

More specifically, the silicon core wire 10 is provided in an inverted U shape inside the straight barrel part 101, and then the reactor 100 is filled with the raw material gas. Specifically, the raw material gas is fed into the reactor 100 by opening a valve 51 illustrated in FIG. 5, so that the inside of the reactor 100 is filled with the raw material gas. In the present embodiment, a flow rate of the raw material gas which flows into the reactor 100, in other words, a feed rate F of the raw material gas, is kept at a predetermined rate until the end of the deposition step S1. Then, in this state, the silicon core wire 10 is heated by causing an electric current to pass through the silicon core wire 10, so that the polycrystalline silicon 20 is deposited on the surface of the silicon core wire 10. The first and second hydrogen gases (described later) and the raw material gas (the “fed gases” in FIG. 5) that have been fed into the reactor 100 are used for a desired application, and are then discharged from the reactor 100 to the outside as illustrated in FIG. 5.

Note that FIG. 5 illustrates merely an example of a structure of the reactor 100, and the structure of reactor 100 is not particularly limited. Furthermore, reaction conditions in the deposition step S1 are not particularly limited. The reactor 100 can be any of various well-known reactors, and the polycrystalline silicon 20 can be deposited under various well-known reaction conditions in the deposition step S1.

The deposition step S1 is completed at a time point when an amount of the polycrystalline silicon 20 that is deposited on the surface of the silicon core wire 10 has reached an amount that is sufficient to obtain the polycrystalline silicon rod 1 having a desired size. Then, a time point (point t1) at which the feed rate F of the raw material gas starts to be decreased from a normal deposition condition is defined as a time point at which the deposition step S1 is completed. In the present embodiment, as shown in FIG. 4, a time period from the start of deposition of the polycrystalline silicon 20 to the end (point t1) of the deposition step S1 is not particularly limited. The time period should be a time period that is taken, until the polycrystalline silicon rod 1 having a desired size is obtained, in accordance with, for example, the feed rate F of the raw material gas and a temperature at the time when the polycrystalline silicon 20 is deposited. The time period is typically 100 hr to 200 hr. The first to third samples (described later) and the comparative sample (described later) are adjusted so that all polycrystalline silicon rods thus obtained have the same size.

<Suitable Handling in Deposition Step/Preparation Before Thermal Treatment Step>

(Surface Temperature of Polycrystalline Silicon and Value of an Electric Current in Deposition Step)

The end of the deposition step S1 is defined to be a time point (point t1) at which the feed rate F of the raw material gas is decreased. Here, in a case where the feed rate F of the raw material gas is decreased while the electric current to be caused to pass through the silicon core wire 10 is kept constant, the surface temperature of the polycrystalline silicon 20 deposited on the silicon core wire 10 may excessively increase as the feed rate F of the raw material gas is decreased. In order to avoid this phenomenon, it is preferable to start decreasing the value of the electric current to be caused to pass through the silicon core wire 10 from the point t2 that is a time point earlier than the time point (point t1) at which the deposition step S1 is completed. In other words, it is preferable to gradually decrease the surface temperature of the polycrystalline silicon 20 by gradually decreasing the above value of the electric current after deposition of the polycrystalline silicon 20 under constant conditions.

In the present embodiment, the surface temperature of the polycrystalline silicon 20 before decreasing the value of the electric current is represented by T1, and hereinafter will be simply referred to as “surface temperature T1”. The surface temperature T1 corresponds to the surface temperature of the polycrystalline silicon 20 when the polycrystalline silicon 20 is deposited under normal conditions. Deposition of the polycrystalline silicon 20 under normal conditions refers to deposition of the polycrystalline silicon 20 under conditions in which the feed rate F of the raw material gas is constant and the value of the electric current is also constant.

Further, in the present embodiment, it is important to carry out, in the thermal treatment step S2 that is performed next, an annealing treatment (thermal treatment) at a temperature which is 30° C. to 100° C. higher than the surface temperature T1 and which is lower than 1030° C. Note that the surface temperature T1 is not particularly limited. The surface temperature T1 should be less than 1000° C., and be any temperature at which the polycrystalline silicon 20 can be deposited. However, it is preferable that the surface temperature T1 be 800° C. or higher and lower than 1000° C. In view of productivity of the polycrystalline silicon 20, it is more preferable that the surface temperature T1 be 900° C. or higher and lower than 1000° C.

Further, in the present embodiment, the value of the electric current to be caused to pass through the silicon core wire 10 starts to be decreased from the point t2. Meanwhile, the surface temperature of the polycrystalline silicon 20 also starts to be decreased from the point t2. The surface temperature of the polycrystalline silicon 20 at the time point (the point t1) at which the feed rate F of the raw material gas is decreased is not particularly limited. However, from the viewpoint of improving the productivity of the polycrystalline silicon 20 and avoiding excessive heating of the polycrystalline silicon 20, it is preferable that the surface temperature of the polycrystalline silicon 20 at the point t1 be lower than the surface temperature T1 by 0° C. (the same temperature as T1) to 100° C., and more preferably lower than the surface temperature T1 by 10° C. to 80° C.

Furthermore, the point t2 is also not particularly limited. In view of the productivity, quality, and the like of the polycrystalline silicon 20, it is preferable that the point t2 be a time point that is approximately 10 minutes to 120 minutes earlier than the point t1, and more preferably a time point that is approximately 20 minutes to 100 minutes earlier than the point t1. Note that in the cases of the first to third samples (described later) and the comparative sample (described later), the point t2 is set to a time point that is 60 minutes earlier than the point t1. Note also that the point t2 is set for preventing an excessive increase in surface temperature of the polycrystalline silicon 20, and it is thus not necessary to set the point t2 if there is no possibility that the surface temperature of the polycrystalline silicon 20 may excessively increase.

(Preceding Feeding of Annealing Gas in Deposition Step)

Further, in the deposition step S1, it is possible to start feeding, into the reactor 100, the first hydrogen gas that serves as a first annealing gas, from the point t3 earlier than the end (point t1) of deposition of the polycrystalline silicon 20. The following will discuss, as an example, a case where the first annealing gas is hydrogen gas. However, the first annealing gas may be at least one gas selected from the group consisting of gases of hydrogen, argon, and helium.

The first hydrogen gas is used as part of hydrogen that is supplied for the annealing treatment in the thermal treatment step S2. The first hydrogen gas is fed separately from the hydrogen gas that is a constituent of the raw material gas. The first hydrogen gas is fed into the reactor 100 together with the raw material gas by opening the valve 52 illustrated in FIG. 5. The point t3 is set to the same time point as the point t1 or to a time point earlier than the point t1. Note however that in order to reliably feed the first hydrogen gas by making it easy to adjust timing of the feeding of the hydrogen gases, it is preferable that the point t3 be set to a time point earlier than the point t1. Furthermore, the point t3 should be set as appropriate in consideration of, for example, various devices that are used to produce the polycrystalline silicon rod 1, a desired size of the polycrystalline silicon rod 1, and deposition efficiency. Normally, the point t3 is set to a time point that is 5 minutes to 1 hour earlier than the point t1.

In the graph of FIG. 4, the first hydrogen gas is arranged to be fed such that the feed rate of the first hydrogen gas is gradually increased so that a peak feed rate f1 of the first hydrogen gas is reached. However, the feed rate can be increased to the peak supply rate f1 at once from a supply rate of 0 (zero). In this case, the point t4 does not exist. In other words, the point t4 is replaced by the point t3. Note that in production of the first to third samples (described later) and production of the comparative sample (described later), the point t3 was set to a time point 30 minutes earlier than the point t1, and the feed rate of the first hydrogen gas was gradually increased until the point t4 over 20 minutes. Further, the feed rate of the first hydrogen gas after the point t4 was kept at the peak feed rate f1. Note however that respective values of peak feed rates f1 for the first to third samples and the comparison sample were arranged to be different from each other.

Further, in the deposition step S1, it is possible to start feeding the second hydrogen gas into the reactor 100 from the point t5 earlier than the end (the point t1) of deposition of the polycrystalline silicon 20. The following will discuss an example in which hydrogen gas is used as the second hydrogen gas. However, this gas may be at least one gas selected from the group consisting of gases of hydrogen, argon, and helium.

The second hydrogen gas is used as part of hydrogen which is fed for the annealing treatment in the thermal treatment step S2. The second hydrogen gas is preferably used as the second annealing gas in the cooling step S3, and is fed separately from the hydrogen gas that is a constituent of the raw material gas. The second hydrogen gas is fed into the reactor 100 together with the raw material gas by opening the valve 53 illustrated in FIG. 5.

The point t5 can be set to the same time point as the point t1 in FIG. 4 or to a time point earlier than the point t1. Note however that in order to reliably feed the second hydrogen gas by making it easy to adjust the timing of feeding the hydrogen gases, it is preferable that the point t5 be set to a time point earlier than the point t1. Furthermore, the point t5 should be set as appropriate in consideration of, for example, various devices that are used to produce the polycrystalline silicon rod 1, a desired size of the polycrystalline silicon rod 1, and deposition efficiency. Normally, the point t5 is set to a time point that is 1 minute to 30 minutes earlier than the point t1.

It is preferable that the feed rate of the second hydrogen gas be lower than the feed rate of the first hydrogen gas. Then, in order to further improve operability related to the feeding of the second hydrogen gas, it is preferable that the feed rate of the second hydrogen gas fed in the deposition step S1 be the same as a feed rate of the second annealing gas fed in the cooling step S3. In the present embodiment, a peak feed rate f2 of the second hydrogen gas fed in the deposition step S1 is equal to a flow rate F2 of the second annealing gas fed in the cooling step S3, as shown in FIG. 4.

In this case, in the thermal treatment step S2, a total amount of the peak feed rate f1 of the first hydrogen gas and the peak feed rate f2 of the second hydrogen gas is equal to a flow rate F1 of the first annealing gas. Then, in the cooling step S3 which is carried out continuously from the thermal treatment step S2, only the feeding of the first hydrogen gas is stopped. The feed rate of the second annealing gas thus becomes a desired rate F2 (=f2) in the cooling step S3.

In the graph of FIG. 4, in the feeding of the second hydrogen gas, the feed rate reaches, from a feed rate of 0 (zero), the peak feed rate f2 at once. For example, the feed rate of the second hydrogen gas can be gradually increased until the peak feed rate f2 is reached. However, since the feed rate of the second hydrogen gas is generally lower than that of the first hydrogen gas, it is preferable in terms of work efficiency and the like that the peak feed rate f2 be reached at once. Note that in the cases of the production of the first to third samples (described later) and the production of the comparative sample (described later), the point t5 was set to a time point that is 5 minutes earlier than the point t1. Further, the peak feed rate f2 of the second hydrogen gas is set to be the same as the flow rate F2 of the second annealing gas.

<Thermal Treatment Step>

Next, as illustrated in FIGS. 3 and 4, the thermal treatment step S2 is carried out after the deposition step S1 is completed. In the thermal treatment step S2, the polycrystalline silicon 20 that has been deposited in the deposition step S1 is annealed in the presence of an annealing gas (first annealing gas) that has been fed, separately from the raw material gas, into the straight barrel part 101 of the reactor 100. The annealing treatment is a thermal treatment in which residual stress that has been generated in the polycrystalline silicon 20 is removed by heating the polycrystalline silicon 20 that has been deposited in the deposition step S1.

In the present experimental embodiment, the composition of the first annealing gas and the flow rate of the first annealing gas can be varied with time. However, as described above, the first annealing gas used in the thermal treatment step S2 does not contain hydrogen gas that is contained in the raw material gas. In other words, the first annealing gas is a combination of annealing gases which are fed into the reactor 100 separately from the raw material gas.

The thermal treatment step S2 is a thermal treatment step in which the polycrystalline silicon 20 that has been deposited in the deposition step S1 is thermally treated in the presence of the first annealing gas. In the thermal treatment step S2, a surface temperature T2 of the polycrystalline silicon (hereinafter, abbreviated as “surface temperature T2”) is adjusted so as to be (the surface temperature T1+30° C.) or higher and (the surface temperature T1+100° C.) or lower for a period of time and also to be lower than 1030° C. Note that the following description will discuss an example in which hydrogen gas is used as the first annealing gas. However, it is possible to obtain the same result by using, as the first annealing gas, at least one gas selected from the group consisting of gases of hydrogen, argon, and helium.

In the thermal treatment step S2, in order to adjust the surface temperature T2, the feed rate of the first annealing gas, the value of the electric current to be caused to pass through the silicon core wire 10, and the like are adjusted. Since the surface temperature T2 is (the surface temperature T1+30° C.) or higher, it is possible to reduce the internal distortion rate of the polycrystalline silicon 20 that has been deposited in the deposition step S1 as compared to a conventional method. Further, it is possible to reduce the collapse rate of the polycrystalline silicon rod 1 as compared to the conventional method, and therefore, it is possible to improve a yield in production of the polycrystalline silicon rod 1. Further, the surface temperature T2 is (the surface temperature T1+100° C.) or lower for a period of time, and is lower than 1030° C. This makes it possible to reduce a phenomenon in which impurities enter the surface of the polycrystalline silicon 20 in the thermal treatment step S2. As a result, it is possible to improve the purity of the polycrystalline silicon 20 after the thermal treatment step S2. This ultimately makes it possible to improve the purity of the entirety of the polycrystalline silicon rod 1.

In the production of the first to third samples (described later) and the production of the comparative sample (described later), the surface temperature of the polycrystalline silicon 20 was increased from the point t1 and was adjusted so as to be the surface temperature T2 at the point t6 in time (see FIG. 4). If the surface temperature of the polycrystalline silicon 20 becomes T2, the surface temperature T2, in any case, is (the surface temperature T1+30° C.) or higher and (the surface temperature T1+100° C.) or lower for a period of time, and is lower than 1030° C. However, in practice, before the surface temperature of the polycrystalline silicon 20 reaches T2, the surface temperature of the polycrystalline silicon 20 is (the surface temperature T1+30° C.) or higher and (the surface temperature T1+100° C.) or lower for a period of time, and is lower than 1030° C.

Note that a time period from the point t1 to the point t6, in other words, a time period that is taken until the surface temperature of the polycrystalline silicon 20 reaches T2 in the thermal treatment step S2, is not particularly limited. However, in order to obtain a high-quality polycrystalline silicon rod 1 having a higher purity, it is preferable that the time period described above be as short as possible. Specifically, it is preferable that the time period be in a range of 1 minute to 30 minutes, and more preferably in a range of 1 minute to 10 minutes. In the production of the first to third samples (described later) and the production of the comparative sample (described later), the time period was set to 5 minutes.

In the present embodiment, the cooling step S3 that is performed next starts at a time point (point t9) at which application of the electric current to the silicon core wire 10 is stopped. In this case, a time period (time period from the point t6 to the point t9) which includes a period having a surface temperature T2 of (the surface temperature T1+30° C.) or higher and (the surface temperature T1+100° C.) or lower and in which the surface temperature T2 is lower than 1030° C. is not particularly limited. Note, however, that in order to obtain the polycrystalline silicon rod 1 having a higher collapse rate and a higher purity as compared to a conventional method, it is preferable that the time period be 10 minutes to 180 minutes. Alternatively, the time period is more preferably 20 minutes to 150 minutes, and more preferably 60 minutes to 120 minutes. In the production of the first to third samples (described later) and the production of the comparative sample (described later), the time period was set to 90 minutes.

It is at the point t7 in time that feeding of the raw material gas is stopped in the thermal treatment step S2, as shown in FIG. 4. When the feeding of the raw material gas is stopped, for example, only feeding of the chlorosilane compound may be stopped. Then, the hydrogen gas constituting the raw material gas can be used as part of the first annealing gas. However, there is a possibility that advanced feeding control may be required and a possibility that the quality of the polycrystalline silicon rod 1 may deteriorate. Therefore, when the feeding of the raw material gas is stopped, it is preferable that both of the chlorosilane compound and the hydrogen gas be reduced and the both be completely stopped.

Note that a time period from the point t1 to the point t7 is not particularly limited. However, in a case where the feeding of the raw material gas is instantaneously stopped, there is a possibility that a defect such as an appearance, quality, and/or the like of the polycrystalline silicon rod 1 may occur. On the other hand, when the above time period is too long, the deposition of the polycrystalline silicon 20 is not completely finished. Therefore, it is preferable that the time period be 1 minute to 60 minutes, and more preferably 3 minutes to 30 minutes. In the production of the first to third samples (described later) and the production of the comparative sample (described later), the time period was set to 15 minutes.

<Suitable Treatment Method in Thermal Treatment Step; Feeding of First Annealing Gas>

The following will discuss a suitable treatment method in the thermal treatment step S2. First, it is preferable that: just before the deposition step S1 completes, the feed rate of the first hydrogen gas be set to the peak feed rate f1 and the feed rate of the second hydrogen gas be set to the peak feed rate f2; and while the first hydrogen gas and the second hydrogen gas are being fed at the aforesaid feed rates into the reactor 100, the thermal treatment step S2 be started continuously from the deposition step S1.

Then, it is preferable that the thermal treatment step S2 satisfy the following conditions. Specifically, in a case where F1 represents the flow rate of the first annealing gas and S represents the cross sectional area of the straight barrel part 101 of the reactor 100 (see FIG. 5), the thermal treatment step S2 preferably includes a period in which a value of F1/S is 20 Nm³/hr/m² or more. In a time period from the point t1 to the point t8, the flow rate F1 of the first annealing gas is a total amount of the peak feed rate f1 and the peak feed rate f2. In other words, in the time period from the point t1 to the point t8, the flow rate F1 of the first annealing gas becomes the maximum total amount of the feed rate of the first hydrogen gas and the feed rate of the second hydrogen gas.

As described above, since the value of the F1/S is 20 Nm³/hr/m² or more, it is possible, in the thermal treatment step S2, to quickly discharge, to the outside of the reactor 100, impurity components that have been generated from parts etc. inside the reactor 100. Therefore, it is possible to have an improved purity of the polycrystalline silicon 20 after the thermal treatment step S2. Note that an upper limit of the value of F1/S is not particularly limited. Therefore, even if hydrogen gas that has been contained in the raw material gas remains inside of the reactor 100, the gas will not cause any adverse effect. However, in order to reduce a cost that is necessary for carrying out the thermal treatment step S2 by reducing an amount of the first annealing gas used, it is preferable to set the upper limit such that the value of F1/S is less than 130 Nm³/hr/m².

Note that in practice, in order to efficiently use the first annealing gas, the feed rate of the first hydrogen gas is reduced from a time point earlier than the point t8 in the thermal treatment step S2. However, even in this case, in the thermal treatment step S2, there is a period in which the total amount of the peak feed rate f1 and the peak feed rate f2 is the flow rate F1 of the first annealing gas. The thermal treatment step S2 thus includes a period in which the value of F1/S is 20 Nm³/hr/m² or more.

Furthermore, a time period (time period from point t1 to point t8) in which the value of F1/S is 20 Nm³/hr/m² or more is not particularly limited. However, in a case where this time period is too short, it would be impossible to sufficiently obtain an impurity reduction effect and a collapse rate reduction effect. In light of the above, the time period is preferably 10 minutes or more, and more preferably minutes or more. On the other hand, in consideration of efficient use of the first annealing gas, an upper limit of the time period is 120 minutes.

In the present embodiment, the feed rate of the first hydrogen gas is decreased from the peak feed rate f1 from the point t8 in time as shown in FIG. 4. Here, at and after the point t8 in time, the total amount of hydrogen gas to be fed into the reactor 100 decreases. Therefore, there is a possibility that the surface temperature T2 may increase. Therefore, the amount of an electric current to be caused to pass through the silicon core wire 10 should be adjusted so that the surface temperature T2 is (the surface temperature T1+30° C.) or higher and (the surface temperature T1+100° C.) or lower for a period of time and that the surface temperature T2 is lower than 1030° C.

In the production of the first to third samples (described later) and the production of the comparative sample (described later), the time period from the point t1 to the point t8 was set to 60 minutes and the feed rate of the first hydrogen gas was decreased from the peak feed rate f1 to 0 (zero) over 30 minutes. The time point at which the feed rate of the first hydrogen gas was set to 0 (zero) is the time point at which the thermal treatment step S2 was completed, specifically, the point t9 that is a time point at which the value of the electric current to be caused to pass through the silicon core wire 10 was set to 0 (zero). The point t9 is, in other words, a start point of the cooling step S3.

As described above, in the thermal treatment step S2, the flow rate F1 of the first annealing gas is limited to a predetermined numerical value range, so that the polycrystalline silicon rod 1 having a value of C1/C2 of 1.0 to 2.0 can be obtained.

The present embodiment has described, as an example, a preferable method for feeding the first annealing gas in the thermal treatment step S2. However, a treatment method in the thermal treatment step S2 is not limited to this method. For example, only the first hydrogen gas can be used as the first annealing gas. Further, for example, in a case where only hydrogen gas is fed by a means identical to a feeding means of the raw material gas after the feeding of the raw material gas is stopped, this hydrogen gas can be part of the first annealing gas. Furthermore, although advanced feeding control is required, the feeding of the first annealing gas may be started from the time point (point t1) at which the thermal treatment step S2 starts.

<Cooling Step>

Next, as illustrated in FIGS. 3 and 4, the cooling step S3 is carried out after the thermal treatment step S2 is completed. In the cooling step S3, the polycrystalline silicon 20 which has been subjected to the annealing treatment in the thermal treatment step S2 is cooled down. In the present embodiment, the polycrystalline silicon 20 described above is naturally cooled. Natural cooling is a thermal treatment in which the electric current caused to pass through the silicon core wire 10 is stopped and the polycrystalline silicon 20 is left, as it is, inside the straight barrel part 101 of the reactor 100.

However, in order to remove the gases staying inside the reactor 100, it is preferable to feed the second annealing gas into the reactor 100 also in the cooling step S3. The second annealing gas is a gas which is fed into the reactor 100 in order to carry out a purge process. The second annealing gas may be at least one gas selected from the group consisting of gases of hydrogen, argon, and helium. The following description will discuss, as an example, a case where the second annealing gas is hydrogen gas. However, it is possible to obtain the same effect with any of the other gases. Further, the second annealing gas is also considered to function to completely discharge the raw material gas to the outside of the reactor 100.

In the present embodiment, the cooling step S3 starts from a time point at which the value of the electric current to be caused to pass through the silicon core wire 10 is set to 0 (zero), that is, from the point t9 in time, as shown in FIG. 4. Further, in the present embodiment, the cooling step S3 is carried out continuously from the thermal treatment step S2, and at the point t9 in time at which the value of the electric current becomes 0 (zero), the feed rate of the first hydrogen gas also becomes 0 (zero). Note however that this timing is merely an example. The time point at which the value of the electric current becomes 0 (zero) and the time point at which the feed rate of the first hydrogen gas becomes (zero) may be different from each other. Note that in the production of the first to third samples (described later) and the production of the comparative sample (described later), the time point at which the value of the electric current became 0 (zero) was arranged to be the same as the time point at which the feed rate of the first hydrogen gas became 0 (zero).

The cooling step S3 preferably satisfies the following conditions. Specifically, in a case where F2 represents the flow rate of the second annealing gas, the cooling step S3 preferably includes a period in which F2/S is 0.4 Nm³/hr/m² or more. A suitable method for feeding the second annealing gas includes, for example, a method in which, as shown in FIG. 4, the flow rate F2 of the second hydrogen gas is kept at a constant value by simply continuing, from the thermal treatment step S2, feeding of the second annealing gas at the peak feed rate f2.

A particularly suitable method for feeding the second annealing gas includes, for example, a method in which the second hydrogen gas is fed continuously in the deposition step S1 and the thermal treatment step S2. Here, the second hydrogen gas has the peak feed rate f2 that is the same as the flow rate F2 of the second annealing gas. In the present embodiment, as shown in FIG. 4, the second hydrogen gas is fed at the peak feed rate f2 continuously from the point t4 in time in the deposition step S1. It is possible to reliably and easily feed the second annealing gas into the reactor 100 by employing the above method.

Note that an upper limit of the flow rate F2 of the second annealing gas is not particularly limited. However, the upper limit is preferably set such that the flow rate F2 is less than 4 Nm³/hr/m². Employing such an upper limit value makes it possible to prevent the polycrystalline silicon after the thermal treatment step S2 from being rapidly cooled by the second annealing gas, and to reduce the internal distortion rate of the polycrystalline silicon 20 after the cooling step S3, as compared with a conventional method. This makes it possible to reduce the collapse rate of the polycrystalline silicon rod 1 as compared to the conventional method, and thus to improve a yield in production of the polycrystalline silicon rod 1.

Further, in the cooling step S3, a period in which the value of F/2S is 0.4 Nm³/hr/m² or more is not particularly limited. The period is, for example, a time period that is taken until the surface temperature of the polycrystalline silicon rod 1 reaches substantially normal temperature (e.g., or less). Note that in the production of the first to third samples (described later) and the production of the comparative sample (described later), the cooling step S3 was completed at the time point when the surface temperature of the polycrystalline silicon rod 1 had reached 30° C.

### <Post-Processing Step>

After the natural cooling and the purge process as described above, the cooling step S3 is completed at the time point when the polycrystalline silicon 20 inside the straight barrel part 101 is cooled down to substantially room temperature. After completion of the cooling step S3, the valve 53 illustrated in FIG. 5 is closed so as to stop the feeding of the second hydrogen gas. As a result, the hydrogen gas inside the reactor 100 is replaced by nitrogen gas. The polycrystalline silicon 20 which has been cooled down to substantially normal temperature after the completion of the cooling step S3 is the polycrystalline silicon rod 1 serving as a final product.

<Variation>

The above-described processes of the deposition step S1, the thermal treatment step S2, and the cooling step S3 are simply examples. Various variations can be adopted. For example, each of numerical values at the points t1 to t9, the flow rate F1 of the first annealing gas, and the flow rate F2 of the second annealing gas can be arbitrarily changed within ranges in which it is possible to achieve an improvement in purity of the entirety of the polycrystalline silicon rod 1 and a reduction in the collapse rate.

Furthermore, in a change in composition and flow rate of the annealing hydrogen gas over time in the thermal treatment step S2, each of the numerical values at the points t1 to t9 can be changed provided that it is still possible to achieve the improvement in purity of the entirety of the polycrystalline silicon rod 1 and the reduction in the collapse rate. It is also possible to change the flow rate F1 of the first annealing gas and the flow rate F2 of the second annealing gas. Furthermore, the cooling step S3 is not an essential step in producing the polycrystalline silicon rod 1, and the cooling step S3 can be omitted.

Furthermore, in the thermal treatment step S2 and the cooling step S3, a gas which is caused to flow into the reactor 100 need not be hydrogen gas as used in the present embodiment. In the thermal treatment step S2 and the cooling step S3, it is possible to cause at least one gas selected from the group consisting of gases of hydrogen, argon, and helium to flow into the reactor 100.

Aspects of the present invention can also be expressed as follows:

A polycrystalline silicon rod in accordance with an aspect of the present invention has: an outer-side total concentration of 100 pptw or less, the outer-side total concentration being obtained by summing up respective concentrations of iron, chrome, and nickel in a portion of up to 4 mm in depth in a radial direction from a surface parallel to a center axis; and a ratio of the outer-side total concentration to an inner-side total concentration of 1.0 or more and 2.5 or less, the inner-side total concentration being obtained by summing up respective concentrations of the iron, the chrome, and the nickel in a portion farther than 4 mm in the radial direction from the surface.

According to the above configuration, in the polycrystalline silicon rod in accordance with an embodiment of the present invention, the outer-side total concentration is 100 pptw or less. Therefore, it is possible to have a lower concentration of impurities (iron, chrome, and nickel) in a portion of the polycrystalline silicon rod in the vicinity of the surface of the polycrystalline silicon rod, as compared to a conventional polycrystalline silicon rod. In other words, it is possible to improve the purity of the portion of the polycrystalline silicon rod in the vicinity of the surface of the polycrystalline silicon rod.

Further, in the polycrystalline silicon rod in accordance with an aspect of the present invention, the ratio of the outer-side total concentration to the inner-side total concentration is 1.0 or more and 2.5 or less. Therefore, it is possible to improve the purity of the entirety of the polycrystalline silicon rod.

The polycrystalline silicon rod in accordance with an aspect of the present invention may have an internal distortion rate of less than 1.0×10⁻⁴ cm⁻¹ in the radial direction. According to this configuration, the internal distortion rate in the radial direction of the polycrystalline silicon rod in accordance with an aspect of the present invention (hereinafter, also abbreviated as “internal distortion rate”) is lower than an internal distortion rate of a conventional polycrystalline silicon rod. Therefore, the collapse rate in production of the polycrystalline silicon rod (hereinafter, abbreviated as “collapse rate”) can be reduced more than that of a conventional polycrystalline silicon rod. Therefore, it is possible to achieve both an improvement in purity of the entirety of the polycrystalline silicon rod and a reduction in collapse rate.

The polycrystalline silicon rod in accordance with an aspect of the present invention may have a diameter of 100 mm or more. In general, the larger the diameter of the polycrystalline silicon rod is, that is, the thicker the polycrystalline silicon rod is, the larger the internal distortion becomes. Such a larger internal distortion increases the risk of collapsing. Further, the thicker the polycrystalline silicon rod is, the higher the concentration of impurities becomes in the portion in the vicinity of the surface. In this regard, according to the above configuration, even in the case of a polycrystalline silicon rod which has a thick diameter of 100 mm or more, which generally has a high concentration of impurities in a portion in the vicinity of a surface and which also has a high collapse rate, it is possible to improve at least the concentration of the entirety of the polycrystalline silicon rod. Furthermore, even in the case of a polycrystalline silicon rod which has a large diameter as described above and which generally has a high concentration of impurities and a high collapse rate, it is possible to produce the polycrystalline silicon rod whose risk of collapsing is lower as compared to a conventional polycrystalline silicon rod.

A method, in accordance with an aspect of the present invention, for producing a polycrystalline silicon rod includes the steps of: depositing polycrystalline silicon on a surface of a silicon core wire by heating the silicon core wire in the presence of a chlorosilane compound and hydrogen; and thermally treating, in the presence of at least one gas selected from the group consisting of gases of hydrogen, argon and helium, the polycrystalline silicon having been deposited in the step of depositing the polycrystalline silicon, the polycrystalline silicon, in the step of thermally treating the polycrystalline silicon, having a surface temperature T2 of (T1+30° C.) or higher and (T1+100° C.) or lower for a period of time, the surface temperature T2 being lower than 1030° C., where T1 represents a surface temperature of the polycrystalline silicon at a time point at which a value of an electric current caused to pass through the silicon core wire in heating the silicon core wire starts to be decreased in the step of depositing the polycrystalline silicon.

According to the above configuration, the surface temperature T2 of the polycrystalline silicon in the above thermal treatment step is T1+30° C. or higher. This makes it possible to lower the internal distortion rate of the polycrystalline silicon that has been deposited in the above deposition step as compared to a conventional method. This makes it possible to reduce the collapse rate of the polycrystalline silicon rod as compared to a conventional method. Therefore, it is possible to improve a yield in production of the polycrystalline silicon rod.

Further, the surface temperature T2 of the polycrystalline silicon in the thermal treatment step is T1+100° C. or lower and is lower than 1030° C. This makes it possible to reduce a phenomenon in which in the thermal treatment step, the surface of the polycrystalline silicon takes in. Therefore, it is possible to improve the purity of the polycrystalline silicon after the thermal treatment step, and consequently to improve the purity of the entirety of the polycrystalline silicon rod.

In other words, conversely, in a case where the surface temperature T2 of the polycrystalline silicon is lower than T1+30° C., an annealing effect of removing the internal distortion of the polycrystalline silicon becomes insufficient, and consequently, the collapse rate becomes high. As a result, the yield in the production of the polycrystalline silicon rod is likely to decrease. On the other hand, in a case where the surface temperature T2 of the polycrystalline silicon is higher than T1+100° C. and is 1030° C. or higher, the concentration of the impurities in the vicinity of the surface of the polycrystalline silicon increases, and thus the concentration of the impurities of the polycrystalline silicon obtained is likely to increase.

The method in accordance with an aspect of the present invention may be configured such that: the step of depositing the polycrystalline silicon and the step of thermally treating the polycrystalline silicon are carried out inside a straight barrel part in a reactor; and the step of thermally treating the polycrystalline silicon includes a period in which a value of F1/S is 20 Nm³/hr/m² or more, where F1 represents a flow rate of a first annealing gas which is the gas that flows into the reactor, and S represents a cross sectional area of the straight barrel part.

According to this configuration, the value of F1/S is Nm³/hr/m² or more, so that, in the thermal treatment step, it is possible to quickly discharge, to the outside of the reactor, the impurity components generated by parts etc. which are present inside the reactor. Therefore, it is possible to improve the purity of the polycrystalline silicon after the thermal treatment step.

Note that, in a case where hydrogen gas is used as the first annealing gas, the first annealing gas does not include hydrogen gas that is a component of the raw material gas which is fed with trichlorosilane (chlorosilane compound). Further, an upper limit of the flow rate F1 of the first annealing gas is not particularly limited. However, the value of F1/S is preferably set to less than 130 Nm³/hr/m 2 in order to reduce an amount of the first annealing gas used.

The method in accordance with an aspect of the present invention may further include the step of cooling the polycrystalline silicon after the step of thermally treating the polycrystalline silicon, the step of cooling including a period in which a value of F2/S is 0.4 Nm³/hr/m² or more, where F2 represents a flow rate of a second annealing gas which is the gas that flows into the reactor.

According to this configuration, the value of F2/S is Nm³/hr/m² or more, so that, in the above cooling step, it is possible to quickly discharge, to the outside of the reactor, the impurity components generated by the parts etc. which are present in the reactor. Therefore, it is possible to improve the purity of the polycrystalline silicon after the cooling step.

Note that an upper limit value of the flow rate F2 of the second annealing gas is not particularly limited. However, it is preferable that the value of F2/S be less than 4 Nm³/hr/m². Setting the value of the F2/S to less than 4 Nm³/hr/m² makes it possible to prevent the polycrystalline silicon after the thermal treatment step from being rapidly cooled by the second annealing gas, and consequently to reduce the internal distortion rate of the polycrystalline silicon after the cooling step, as compared with a conventional method. This makes it possible to reduce the collapse rate of the polycrystalline silicon rod as compared to a conventional method, and consequently to improve the yield in production of the polycrystalline silicon rod.

A method, in accordance with an aspect of the present invention, for thermally treating polycrystalline silicon includes the step of thermally treating the polycrystalline silicon inside a straight barrel part of a reactor in the presence of at least one gas selected from the group consisting of gases of hydrogen, argon and helium, the step of thermally treating the polycrystalline silicon including a period in which a value of F1/S is 20 Nm³/hr/m² or more, where F1 represents a flow rate of a first annealing gas which is the gas that flows into the reactor, and S represents a cross sectional area of the straight barrel part.

[Additional Remark]

The present invention is not limited to the embodiments and variations described above, but may be altered in various ways by a skilled person within the scope of the claims. Specifically, any embodiment based on a proper combination of technical means disclosed in different embodiments and variations described above is also encompassed in the technical scope of the present invention.

### EXAMPLES

The following will discuss Examples of the present invention. Note that, in the following description, the term “first production condition” refers to a condition in which the surface temperature T2 in the annealing treatment is (the surface temperature T1+30° C.) or higher and (the surface temperature T1+100° C.) or lower for a period of time and also is lower than 1030° C. Further, the term “second production condition” refers to a condition in which the value of F1/S is 20 Nm³/hr/m² or more, and preferably less than 130 Nm³/hr/m². Furthermore, the term “third production condition” refers to a condition in which the value of F2/S is 0.4 Nm³/hr/m² or more, and preferably less than 4 Nm³/hr/m².

<Sample Production>

First, respective polycrystalline silicon rods 1 in accordance with Examples 1 to 3 of the present invention were produced by a production method similar to that in the above-described embodiment of the present invention, with use of a reactor 100 and other production facilities that are similar to those in the above-described embodiment of the present invention. Hereinafter, the polycrystalline silicon rods 1 in accordance with respective Examples 1 to 3 of the present invention will be abbreviated as “first to third samples.

Specifically, as shown in Table 1 below, the surface temperature T1 at the point t2 in time in the deposition step S1 was set to 970° C. for each of the first to third samples. The surface temperature T2 at the point t6 in time in the thermal treatment step S2 was set to 1010° C. for each of the first to third samples. On the other hand, F1/S and F2/S in the thermal treatment step S2 were made different between Examples 1 to 3.

Specifically, the first sample was produced in a state in which only the first production condition was satisfied and the second and third production conditions were not satisfied. The second sample was produced in a state in which the first and second production conditions were satisfied and the third production condition was not satisfied. The third sample was produced in a state in which all of the first to third conditions were satisfied. Furthermore, each of the first to third samples and the comparison sample was arranged to have a diameter of 120 mm.

The polycrystalline silicon rod (not shown) in accordance with Comparative Example of the present invention was also produced by following the steps similar to those in the embodiment of the present invention. Hereinafter, the polycrystalline silicon rod in accordance with Comparative Example of the present invention will be abbreviated as “comparative sample”. Further, as shown in Table 1 below, the comparative sample was produced under the same conditions as the third sample except for the first production condition. The surface temperature T1 of the polycrystalline silicon 20 at the point t2 in the deposition step S1 was set to 970° C. as in the cases of the first to third samples.

TABLE 1

| | | | | | | | | Internal | |
|---|---|---|---|---|---|---|---|---|---|
| | | | F1/S | F2/S | | | | Distortion | |
| | T1 | T2 | (Nm³/ | (Nm³/ | C1 | C2 | | Rate | Overall |
| | (° C.) | (° C.) | hr/m²) | hr/m²) | (pptw) | (pptw) | C1/C2 | (cm⁻¹) | Evaluation |
| First | 970 | 1010 | 14.3 | 0.3 | 80-100 | 40-60 | 1.3-2.5 | 8 × 10⁻⁶ | Good |
| Sample | | | | | | | | | |
| Second | 970 | 1010 | 50.3 | 0.3 | 60-80 | 40-60 | 1.0-2.0 | 8 × 10⁻⁶ | Good |
| Sample | | | | | | | | | |
| Third | 970 | 1010 | 52.0 | 2.0 | 40-60 | 40-60 | 1.0-1.5 | 8 × 10⁻⁶ | Good |
| Sample | | | | | | | | | |
| Comparative | 970 | 1100 | 52.0 | 2.0 | 400-600 | 40-60 | 6.7-15 | 4 × 10⁻⁶ | Poor |
| Sample | | | | | | | | | |

<Sample Evaluation>

Next, the outer-side total concentration C1, the inner-side total concentration C2, C1/C2, and the internal distortion rate were calculated for each of the first to third samples and the comparison sample by a method similar that in the embodiment of the present invention. Table 1 above shows each calculation result. Note that, in Table 1 above, an overall evaluation “good” indicates a case where good results were obtained for both of the C1/C2 and the internal distortion rate. In contrast, the overall evaluation “poor” indicates a case where a poor result was obtained for at least one of the C1/C2 and the internal distortion rate.

The expression “good result of C1/C2” refers to a case where C1/C2 takes a value within a numerical value range of 1.0 to 2.5. Therefore, a case where C1/C2 takes a value outside the numerical value range of 1.0 to 2.5 is expressed as a “poor result of C1/C2”. Further, the expression “good result of internal distortion rate” refers to a case in which the internal distortion rate is less than 1.0×10⁻⁴ cm⁻¹. Therefore, a case where the internal distortion rate is 1.0×10⁻⁴ cm−1 or more is expressed as a “poor result of internal distortion rate”.

First, for the first to third samples, the numerical value range of C1/C2 was found to be better (overall evaluation “good”) than that of a conventional polycrystalline silicon rod. On the other hand, as for the comparative sample, the outer-side total concentration C1 was in a significantly higher numerical range (400 pptw to 600 pptw) than the outer-side total concentration C1 of the first to third samples. Therefore, the comparative example was evaluated to be a poor result (overall evaluation “poor”). Next, with regard to the inner-side total concentration C2, all of the first to third samples and the comparison sample were in the same numerical range. From this, it was found that the production conditions had substantially no effect on the inner-side total concentration C2.

On the other hand, as for the outer-side total concentration C1, different calculation results were obtained respectively for the first to third samples and the comparative sample. In particular, the outer-side total concentration C1 of the comparative sample was in a significantly higher numerical range (400 pptw to 600 pptw) than the outer-side total concentrations C1 of the first to third samples. It is considered that this result is mainly due to the fact that the value of the surface temperature T2 of only the comparative sample is 1100° C. during the annealing treatment and that the value is higher than the surface temperature T2 (1010° C.) of the first to third samples during the annealing treatment.

As for the first to third samples, although the production conditions other than the surface temperature T2 during the annealing treatment are different from each other, a difference in the numerical value range of the outer-side total concentration C1 is smaller than a difference from the comparative sample. From this, it can be inferred that the surface temperature T2 during the annealing treatment greatly affects the outer-side total concentration C1.

### REFERENCE SIGNS LIST

1 polycrystalline silicon rod
10 silicon core wire
20 polycrystalline silicon
21 surface
100 reactor
101 straight barrel part
C1 outer-side total concentration
C2 inner-side total concentration
F1 flow rate of first annealing gas (flow rate of at least one gas selected from the group consisting of gases of hydrogen, argon and helium)
F2 flow rate of second annealing gas (flow rate of at least one gas selected from the group consisting of gases of hydrogen, argon and helium)
f1 peak feed rate of first hydrogen gas
f2 peak feed rate of second hydrogen gas
T1 surface temperature (surface temperature of polycrystalline silicon at time point when amount of chlorosilane compound and hydrogen starts to be decreased)
T2 surface temperature (surface temperature of polycrystalline silicon in thermal treatment step)
S cross sectional area
AX center axis

1. A polycrystalline silicon rod having:
an outer-side total concentration of 100 pptw or less, the outer-side total concentration being obtained by summing up respective concentrations of iron, chrome, and nickel in a portion of up to 4 mm in depth in a radial direction from a surface parallel to a center axis; and
a ratio of the outer-side total concentration to an inner-side total concentration of 1.0 or more and 2.5 or less, the inner-side total concentration being obtained by summing up respective concentrations of the iron, the chrome, and the nickel in a portion farther than 4 mm in the radial direction from the surface.

2. The polycrystalline silicon rod according to claim 1, having an internal distortion rate of less than 1.0×10⁻⁴ cm⁻¹ in the radial direction.

3. The polycrystalline silicon rod according to claim 1, having a diameter of 100 mm or more.

4. A method for producing a polycrystalline silicon rod, comprising the steps of:
depositing polycrystalline silicon on a surface of a silicon core wire by heating the silicon core wire in the presence of a chlorosilane compound and hydrogen; and
thermally treating, in the presence of at least one gas selected from the group consisting of gases of hydrogen, argon and helium, the polycrystalline silicon having been deposited in the step of depositing the polycrystalline silicon,
the polycrystalline silicon, in the step of thermally treating the polycrystalline silicon, having a surface temperature T2 of (T1+30° C.) or higher and (T1+100° C.) or lower for a period of time, the surface temperature T2 being lower than 1030° C., where T1 represents a surface temperature of the polycrystalline silicon at a time point at which a value of an electric current caused to pass through the silicon core wire in heating the silicon core wire starts to be decreased in the step of depositing the polycrystalline silicon.

5. The method according to claim 4, wherein:
the step of depositing the polycrystalline silicon and the step of thermally treating the polycrystalline silicon are carried out inside a straight barrel part in a reactor; and
the step of thermally treating the polycrystalline silicon includes a period in which a value of F1/S is 20 Nm³/hr/m² or more, where F1 represents a flow rate of a first annealing gas which is the gas that flows into the reactor, and S represents a cross sectional area of the straight barrel part.

6. The method according to claim 5, further comprising the step of cooling the polycrystalline silicon after the step of thermally treating the polycrystalline silicon,
the step of cooling including a period in which a value of F2/S is 0.4 Nm³/hr/m² or more, where F2 represents a flow rate of a second annealing gas which is the gas that flows into the reactor.

7. A method for thermally treating polycrystalline silicon, the method comprising the step of
thermally treating the polycrystalline silicon inside a straight barrel part of a reactor in the presence of at least one gas selected from the group consisting of gases of hydrogen, argon and helium,
the step of thermally treating the polycrystalline silicon including a period in which a value of F1/S is 20 Nm³/hr/m² or more, where F1 represents a flow rate of a first annealing gas which is the gas that flows into the reactor, and S represents a cross sectional area of the straight barrel part.
